(19) United States
(12) Patent Application Publication
(10) Pub. No.: US 2006/0212287 A1
(43) Pub. Date: Sep. 21, 2006

(54) Method for data processing with a view to extracting the main attributes of a product

(75) Inventor: Franck Bigalet, Torchefelon (FR)

Correspondence Address: HESLIN ROTHENBERG FARLEY & MESITI PC, 5 COLUMBIA CIRCLE, ALBANY, NY, 12203, US

(73) Assignee: SIGHT'UP, Torchefelon (FR)

(21) Appl. No.: 11/359,697

(22) Filed: Feb. 22, 2006

Related U.S. Application Data
(60) Provisional application No. 60/664,625, filed on Mar. 23, 2005.

(30) Foreign Application Priority Data
Mar. 7, 2005 (FR) 05.50596

(51) Int. Cl. G06F 17/21

(52) U.S. Cl. 704/10

(57) ABSTRACT

A method is provided for data processing with a view to determining the main attributes of a product defined by a description including a plurality of words in which, for each word, one determines whether it belongs to one or more predetermined sets or glossaries. Then, for each word that belongs to one or more glossaries: one assigns to the word a plurality of codings produced depending on the predetermined glossary to which the word belongs and on the other words in the description and/or the glossaries to which the other words belong; and one uses a dual-class categoriser to analyse all these codings produced for the word in order to determine whether the word is a main attribute of the product.

The present invention relates to a method for processing data representative of a product with a view to indexing it and accessing it using search engines with optimised relevance.

The invention has a particular application, but is not confined to, processing data that is representative of products offered for sale by commercial websites on the Internet. The term “product” is taken to mean not only manufactured products but also services that can be the subject of a commercial offering and which can also be purchased online.

In the rest of this description, the invention will therefore be described in relation to examples associated with this specific application without the scope of the invention necessarily being confined to this application.

### DESCRIPTION OF THE PRIOR ART

Currently, commercial websites that offer products and services for sale on the Internet have an economic interest in disseminating their offerings through specialist search engines made available by referencing websites. These specialist search engines suggest various categories of products and services to the purchaser and enable the potential purchaser to search on keywords that correspond to the features of the product.

To achieve this, the referencing website collects data that is representative of products marketed by the various commercial websites and determines the main features of these products on which it will be possible to perform keyword searches.

It is obvious that this processing is a relatively complex operation because it depends predominantly on the language used to describe the product, the vocabulary relating to an item category and the syntax used.

At present, the attributes or features of a product are extracted by manual, systematic analysis of all the offerings. This processing makes it possible to profile each product by attributes, thereby allowing classification of such products in various categories. The various products are then catalogued in databases which make it possible to access the products by selecting the various fields of the database.

More precisely, some commercial websites which operate special databases make it possible to narrow down the purchaser's-choice by allowing a choice of optional criteria that depend on criteria that have been previously keyed in.

It is apparent that these techniques for extracting features involve a considerable amount of tedious drudgery because they require individual manual analysis of each of the products that are submitted by the commercial website. In addition, classification of the various products in the databases is not really technically satisfactory. The way that offerings are structured in databases is relatively suitable for products of a technical nature, e.g. in the field of IT, because each product has a finite number of features the variation of which can be stated within the framework of a relatively restricted choice.

In contrast, classification in databases is not suitable for products associated with sectors of industry where the offering is extremely variable and loosely defined. One might cite the example of clothing. Because structuring into databases constrains the potential features of a product to a certain extent, this mechanism is ill suited to rapidly changing markets.

In addition, it has been observed that this method of extracting the features of a product has deficiencies in terms of relevance.

In the following description: “blanket 7 ×100, made of plain polarfleece, delivered in PVC bag, 100% polyester”, the terms “blanket” and “bag” each correspond to a potential definition of a type of item.

Using present techniques, the product thus described is therefore regarded both as a “blanket” and a “bag”. This result is obviously not relevant because the item described is a blanket and not the bag which is sales accessory. The same type of logic is encountered with a description of an item such as “black dress with a red belt” in which current methods determine “belt” and “red” as keywords which correspond to the features of an accessory to the main item which is in fact a “black dress”.

In other words, existing techniques have inadequacies in terms of relevance.

One object of the invention is to make it possible to optimise indexing relevance by more appropriate processing of cases where the description of a product comprises several words that belong to a single type of attribute and in which only one of these words represents an important feature of the product.

Another object of the invention is to provide a method that can be adapted easily to various languages that are used to describe the products.

### SUMMARY OF THE INVENTION

The invention therefore relates to a method of determining the main features of a product defined by a description that involves a plurality of words.

This method involves several successive stages.

Initially and for each word in the description, a check is made to determine whether the word belongs to one or more predetermined sets or glossaries. The following operations are then performed for each of the words that belong to one or more glossaries.

In a first stage, a plurality of codings are assigned to the word. These codings are produced on the basis of the predetermined glossary to which the word in question belongs as well as the glossaries to which the other words in the description belong, if applicable.

In a second stage, all these codings produced for the word in question are analysed by a dual-class categoriser so as to determine whether the word in question is a main attribute of the product.

In this way, the attributes or features of a product are extracted by comparing the words in its description to glossaries. These glossaries are sets of words relating to one type of feature of the product. Each item category therefore has particular features. By way of example, in the category for clothing items, there are various glossaries which each group together the garment type, colour, material or other specific features of a clothing item.

The method used by the invention requires the use of glossaries that are the result of manual inventorying (which is as exhaustive as possible) of the terms relating to the quality of the glossary in question in a representative sample that is as reduced as possible.

Overall, all the product descriptions are subjected to comparison with these various glossaries. If there is concordance between a term in the description and a term in one of the glossaries, the term thus defined is then regarded as defining a potential attribute corresponding to the glossary to which it belongs.

In other words, the invention involves performing processing on every description which is not confined to simply searching for concordance with terms in a glossary but, over and above this, performs a number of operations intended to eliminate occurrences in a glossary that are not relevant. More precisely, a certain number of codings are associated with each of the terms that are likely to constitute an essential attribute of the product because they belong to a glossary. These codings are produced depending on the other terms in the description which belong to glossaries. In this way, it is possible to detect cases where occurrence in a glossary does not necessarily signify that a word represents a main feature of the product.

By way of example, the occurrence in a description of two words capable of representing an item type poses a risk of error when determining the “type” attribute of the item. In the phrase “black dress with a red belt”, the terms “dress” and “belt” are both representative of a garment type although only the term “dress” corresponds to the actual item type in question. Determining the position of each of the words relating to an item type within the description can make it possible to differentiate cases and to assign the term which is actually relevant to the “type” attribute—in this case the word “dress”.

Analysing the various codings assigned to a given word therefore makes it possible, using self-learning techniques, to confirm that the word in question is actually a product feature for the type of glossary to which it belongs. Conversely, it makes it possible to eliminate cases where it corresponds to a feature of an accessory of the item or even an auxiliary feature.

In practice, the processing in accordance with the invention may advantageously involve an initial stage consisting of substituting, in the description, the words belonging to a glossary by the name of said glossary so as to produce distinctive codings by analysing the description after substitution.

In other words, the processing in accordance with the invention may be performed on a description in which the terms belonging to a glossary have been replaced by the actual name of the glossary. In this substituted description, the characteristic terms are no longer present and their relevance is therefore determined depending on their position in the description relative to the other terms which may themselves have been substituted.

In order to achieve a higher level of performance, it may be advantageous to generate additional codings. Thus, for each word that belongs to a given glossary, one may assign to said word a plurality of additional codings that are produced depending on the predetermined glossary to which the word in question belongs and on the other words in the description.

These additional codings are therefore produced depending on the other words in the description, not depending on the glossaries to which these words belong. These additional codings are therefore performed by taking into account the description before the substitution operations mentioned above.

In practice multiple codings of varying complexity can be used. These codings may be combined with each other in accordance with a logic that is specific to the invention.

The method may comprise a stage during which a restricted number of codings is selected from a group of possible codings. It may be useful to only retain certain particular codings which make it possible to discriminate certain more relevant cases.

In practice, selecting these various codings may be dependent on the glossary to which the word for which one is seeking to adapt the codings belongs. In other words, some particular codings will be retained in order to process words that belong to a specific glossary. These codings may differ depending on the glossary in question, but also depending on the product category or even the description language.

In practice there is an almost infinite number of possible codings, some of which are detailed below.

Certain codings can take into consideration words located before or after the word for which the coding is produced. More precisely, a first coding may involve identifying the words (or glossaries to which they belong) that are located up to a given number of positions after or before the word for which the coding is produced. In other terms, one observes what are the words in the vicinity of a term that belongs to a glossary in order to draw conclusions regarding the degree of relevance of the term in question as a feature of the item.

More sophisticated coding may involve combing the coding stated above for words located before and words located after the term under consideration.

Another type of coding may involve counting the number of words in a description which belong to the same glossary as the glossary to which the word to be coded belongs after deduplication.

In this case, this coding makes it possible to detect whether several words in the description correspond to the same type of feature, e.g. a colour or a shape. In this case, combination with a different coding can be useful.

Another type of coding can be to assign to a given word, a coding that corresponds to the number of occurrences of the given word in the description of the product. In other words, this coding makes it possible to detect whether the same term occurs several times in the description, which may indicate that it is probably one of the main features of the item.

In another type of coding, one can assign to a given word, the position in the description of that word compared with the other words belonging to the same glossary but which are different. In other words, in a description in which there are two terms belonging to the same glossary, these two different terms will therefore not be assigned the same coding and this makes it possible to differentiate different cases. It is thus possible to differentiate cases where a term corresponds to a main feature of the item or to an accessory or an incidental aspect.

By way of example, in the description “black dress with a red belt”, the terms “black” and “red” that belong to the same glossary of colours will not be given the same coding.

Another type of coding assigned to a given word may involve identifying the words (or the glossaries to which they belong) that are located between the word in question and the first word belonging to the same glossary located after the given word in the description.

In other words, if several words belong to the same glossary, this coding is sensitive to the terms that are located between these two words that belong to the same glossary. More precisely, this coding makes it possible to detect whether, between two words that belong to the same glossary, there are language terms that are not distinctive of the product or, conversely, that correspond to a feature of another kind.

Thus, in the phrase “blue or red or green”, the terms blue, red and green correspond to potential colour features between which there is conjunction indicating that the terms are on an equal footing in terms of relevance.

Conversely, in the expression “a black dress with a red belt”, the terms “dress” and “belt” belong to the same item type glossary. The presence of the term “black” which is itself a potential colour feature and of the term “with” is representative of a case where one can assume that the second term which is representative of the features of the item, namely “belt”, corresponds to an accessory of the main item, namely “dress”.

In practice, multiple codings may be devised without extending beyond the scope of the invention.

In practice, the method requires an initial training stage by manually processing a certain number of examples in order to program the dual-class categoriser.

### BRIEF DESCRIPTION OF THE DRAWINGS

The way in which the invention is implemented and its resulting advantages will become more apparent from the description of the embodiment given below, reference being made to the accompanying drawings:

FIG. 1 comprises a Table showing the processing in accordance with the invention of a product description.

### DESCRIPTION OF THE PREFERRED EMBODIMENTS

As already stated, the invention relates to a method for processing data that describes products and, more generally, any commercial offering in order to extract its main attributes, thus allowing relevant searching.

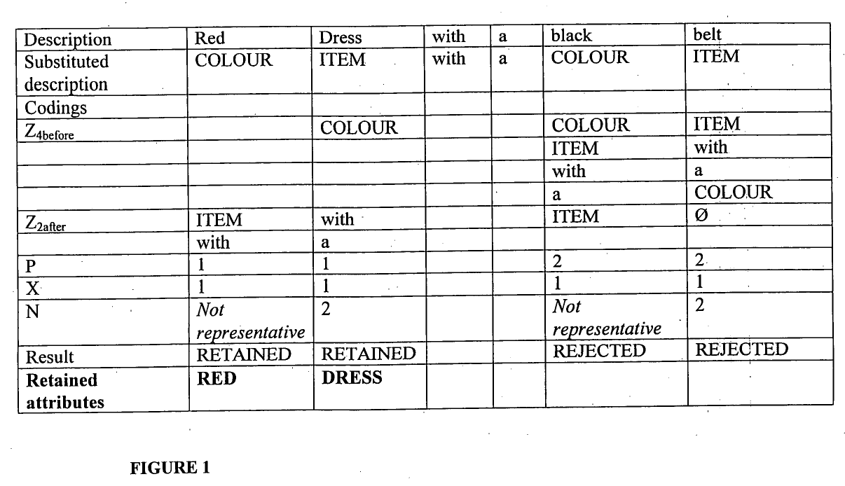

FIG. 1 shows a simplified example of the processing of a brief description but it is self evident that the same principle can be applied to much more extensive descriptions.

In a first stage, the description is analysed in order to determine whether each of its words belong to predetermined glossaries. The description may undergo prior processing using a lemmatiser which involves substituting those words that can be inflected in terms of gender and number by their masculine and singular form.

Each of the words is then compared to the content of various glossaries so that, in the example in FIG. 1, the terms “dress” and “belt” are identified as belonging to the “ITEM” glossary defined as a set of clothing items.

Similarly, the terms “red” and “black” are identified as belonging to the “COLOUR” glossary which groups together garment colours.

In an initial stage, a substituted description is produced by replacing each of the words that belong to a glossary by the name of the corresponding glossary so that the phrase “the red dress with a black belt” is substituted by the following description “the ITEM COLOUR with an ITEM COLOUR”.

The various distinctive codings are then produced for each of the terms that belong to a glossary. As already stated, an unlimited number of codings can be produced and the following description only adopts a limited number of codings for the sake of simplicity.

A first type of coding involves identifying the terms located before and after the word in question.

More precisely, it may be advantageous, in the clothing item category and the French language, to identify those terms that can be located up to four positions before the word under consideration, making allowance for the fact that the word can be located at the start of the description and be preceded by a number of words that is less than four. The lines referred to as Z_{4before} in the Table in FIG. 1 state the four corresponding codings for each of the terms belonging to a glossary.

The same type of coding is produced in order to determine those terms located one or two positions after the word in question. These codings are grouped together on the lines Z_{2after} in the Table in FIG. 1.

Line P in the Table in FIG. 1 shows another type of coding produced for each of the topics belonging to a glossary. More precisely, this coding involves identifying the position of the term in question in the description relative to the other words belonging to the same glossary. The term “dress” belonging to the “ITEM” glossary is the first term in the description which belongs to this glossary, the term “belt” being second to it. The same order is encountered by comparing the term “red” with the term “black”.

Line X in the Table in FIG. 1 identifies another type of coding involving counting the number of times that the word in question occurs in the description. In the actual example in the Table in FIG. 1, each of the terms belonging to a glossary only appears once in the description.

Line N in the Table in FIG. 1 shows a different type of coding which is considered relevant only for words belonging to the “ITEM” glossary. This coding is not representative for words in a different glossary and more particularly the “COLOUR” glossary. In respect of the term “dress” which belongs to the “ITEM” glossary, a second term, namely the term “belt” belongs to the same “ITEM” glossary so that the N coding assumes the value 2 for the word “dress”.

The same goes for all other terms in the “ITEM” glossary, especially for the term “belt”.

During the training phase, the example in FIG. 1 is analysed to reach the conclusion that the terms “dress” and “red” must be retained in order to define the item and colour attributes whereas, conversely, the terms “belt” and “black” will be rejected. This example therefore is involved in programming the dual-class categoriser intended to analyse the result of coding.

Obviously, the example in FIG. 1 which is simplified for illustrative purposes can be made more complex in order to reflect real cases whilst still retaining the same operating principle.

It is therefore evident that the method according to the invention has numerous advantages:
it can be adapted to suit various languages because of the ability of the method to analyse the structure of the way a description is built up;
it needs only a very small number - of typical examples intended for training compared with currently known conventional methods;
extremely high relevance with almost total elimination of noise because its accuracy is close to 100%.

1. A method for data processing with a view to determining the main attributes of a product defined by a description including a plurality of words in which:
for each word, one determines whether the word belongs to one or more predetermined sets or glossaries;
for each word belonging to the one or more glossaries:
one assigns to said word a plurality of codings produced depending on a predetermined glossary to which said word belongs and glossaries to which other words in the description belong, and
one uses a dual-class categoriser to analyse all the codings produced for said word in order to determine whether said word is a main attribute of the product.

2. A method as claimed in claim 1, comprising a stage involving substituting those words in the description which belong to a glossary by a name of said glossary, then producing codings by analysing the description after substitution.

3. A method as claimed in claim 1 in which, for each word belonging to one or more glossaries:
one assigns to said word a plurality of additional codings produced depending on the predetermined glossary to which said word belongs and on other words in the description, and
one uses a dual-class categoriser to analyse all the additional codings produced for said word in order to determine whether said word is a main attribute of the product.

4. A method as claimed in claim 1, further comprising a stage involving selecting a restricted number of codings chosen from a group of potential codings.

5. A method as claimed in claim 4, in which the selected codings depend on the glossary to which said word belongs.

6. A method as claimed in claim 1, wherein the dual-class categoriser is programmed by self-learning.

7. A method as claimed in claim 1, wherein a coding (Zₙ) assigned to a given word involves identifying proximate words, or glossaries to which the proximate words belong, that are located up to n positions after or before said given word in the description.

8. A method as claimed in claim 1, wherein a coding (Zₙₘ) assigned to a given word involves identifying subsequent words, or glossaries to which the subsequent words belong, that are located up to n positions after said given word, and preceding words, or glossaries to which preceding words belong, that are located up to m positions before said given word in the description.

9. A method as claimed in claim 1, wherein a coding (A) assigned to a given word involves identifying intervening words, or the glossaries to which the intervening words belong, that are located between said given word and a first word belonging to the same glossary located after the given word in the description.

10. A method as claimed in claim 1, wherein a coding (X) assigned to a given word involves counting number of occurrences of said given word in the description.

11. A method as claimed in claim 1, wherein a coding (N) assigned to a given word involves counting number of words in the description belonging to the same glossary as that to which the given word belongs and which are different from the given word.

12. A method as claimed in claim 1, wherein a coding (P) assigned to a given word involves identifying a position of said given word in the description compared with the other words in the description that belong to the same glossary.
